(19) United States
(12) Patent Application Publication
(10) Pub. No.: US 2012/0078559 A1
(43) Pub. Date: Mar. 29, 2012

(54) FAST STEADY STATE FIELD ANALYSIS METHOD, FAST STEADY STATE FIELD ANALYSIS APPARATUS, FAST STEADY STATE FIELD ANALYSIS PROGRAM, AND COMPUTER-READABLE RECORDING MEDIUM OF STORING ITS PROGRAM

(75) Inventor: Kenji MIYATA, Hitachinaka (JP)

(73) Assignee: Hitachi, Ltd.

(21) Appl. No.: 13/222,237

(22) Filed: Aug. 31, 2011

(30) Foreign Application Priority Data
Sep. 27, 2010 (JP) 2010-214677

(51) Int. Cl. G06F 19/00

(52) U.S. Cl. 702/85

(57) ABSTRACT

In the fast steady state field analysis method, the following processes are executed in a computer. First, the physical quantity of the analysis object is calculated through transient analysis based on an analysis execution module in which a differential equation including the time-derivative term is made discrete. A time-averaged value of the calculated physical quantities of the analysis object that are present in a set time width is calculated. The physical quantity of the analysis object calculated in step 21 for each time step is corrected by using a time harmonic order correction equation for time averaging with the calculated time-averaged value taken into consideration. After the physical quantity became in the steady state, the physical quantity of the analysis object in the steady state is calculated through transient analysis in which a differential equation is used. The calculated physical quantity of the analysis object in the steady state is displayed.

### CLAIM OF PRIORITY

The present application claims priority from Japanese Patent application serial no. 2010-214677, filed on Sep. 27, 2010, the content of which is hereby incorporated by reference into this application.

### BACKGROUND OF THE INVENTION

1. Technical Field

The present invention relates to a fast steady state field analysis method, a fast steady state field analysis apparatus, a fast steady state field analysis program, and a computer-readable recording medium of storing its program.

2. Background Art

Analysis methods using a finite-element method have been known as conventional typical non-linear magnetic field analysis methods. Some non-linear magnetic field analysis methods are used together with an iterative method based on the incomplete Cholesky conjugate gradient method (ICCG method) or with the Newton-Raphson method by which magnetic permeability is successively corrected. These methods is described in, for example, Takayoshi Nakata and Norio Takahashi, “A finite element method in electrical engineering”, Morikita Publishing Co., pp. 195-208, 1986.

When a solution is obtained by performing transient analysis on a differential equation that handle a transient phenomena having a time-derivative term and when the time constant of a time damping term is long, transient analysis involving many time steps is necessary. To solve this problem, TP-EEC method, polyphase alternate current TP-EEC method, and TDC method were developed. The TP-EEC method is described in Tadashi Tokumasu, Masafumi Fujita, and Takashi Ueda, “Problems remained in practical usage of 2 dimensional electromagnetic analyses (3)”, joint technical meeting on static apparatus and rotary machinery, IEE Japan, SA-08-62/RM-08-69, pp, 77-82, 2008, and in Yasuhito Takahashi, Tadashi Tokumasu, Masafumi Fujita, Shinji Wakao, Takeshi Iwashita, and Masanori Kanazawa, “Improvement of convergence characteristic in nonlinear transient eddy-current analyses using the error correction of time integration based on the time-periodic FEM and the EEC method”, Transactions of the Institute of Electrical Engineers of Japan B, Vol. 129 (2009), No. 6, pp. 791-798. The polyphase alternate current TP-EEC method is described in Tadashi Tokumasu, Masafumi Fujita, and Takashi Ueda, “Problems remained in practical usage of 2 dimensional electromagnetic analyses (4)”, joint technical meeting on static apparatus and rotary machinery, IEE Japan, SA-09-6/RM-09-6, pp, 29-34, 2009. The TDC method is described in Kenji Miyata “Fast analysis method of time-periodic nonlinear fields”, joint technical meeting on static apparatus and rotary machinery, IEE Japan, MAG-10-8/SA-10-8/RM-10-8, pp. 43-48, 2010.

### CITATION LIST

### Non-Patent Literature

[Non-patent Literature 1] Takayoshi Nakata and Norio Takahashi, “A finite element method in electrical engineering”, Morikita Publishing Co., pp. 195-208, 1986

[Non-patent Literature 2] Tadashi Tokumasu, Masafumi Fujita, and Takashi Ueda, “Problems remained in practical usage of 2 dimensional electromagnetic analyses (3)”, joint technical meeting on static apparatus and rotary machinery, IEE Japan, SA-08-62/RM-08-69, pp, 77-82, 2008

[Non-patent Literature 3] Yasuhito Takahashi, Tadashi Tokumasu, Masafumi Fujita, Shinji Wakao, Takeshi Iwashita, and Masanori Kanazawa, “Improvement of convergence characteristic in nonlinear transient eddy-current analyses using the error correction of time integration based on the time-periodic FEM and the EEC method”, Transactions of the Institute of Electrical Engineers of Japan B, Vol. 129 (2009), No. 6, pp. 791-798

[Non-patent Literature 4] Tadashi Tokumasu, Masafumi Fujita, and Takashi Ueda, “Problems remained in practical usage of 2 dimensional electromagnetic analyses (4)”, joint technical meeting on static apparatus and rotary machinery, IEE Japan, SA-09-6/RM-09-6, pp, 29-34, 2009

[Non-patent Literature 5] Kenji Miyata “Fast analysis method of time-periodic nonlinear fields”, joint technical meeting on static apparatus and rotary machinery, IEE Japan, MAG-10-8/SA-10-8/RM-10-8, pp. 43-48, 2010

### SUMMARY OF THE INVENTION

### Technical Problem

In the TP-EEC method, periodicity related to time is directly used. Therefore, basically, if transient analysis is not carried out in a half period or one period, the physical quantities of an analysis object cannot be corrected. This correction is completed in about three times. When a half-period boundary condition is met, however, calculation for about 1.5 periods is necessary until the correction is completed. When one-period boundary condition is met, calculation for about three periods is necessary until the correction is completed. In one calculation for correction, matrix equations must be solved. This is problematic in that time taken to carry out calculation for correction is relatively prolonged. Furthermore, since calculations for about 1.5 or three periods are necessary for correction, if the period of a basic frequency component is very long, not only a long calculation time is necessary for correction, but also the damping field is somewhat damped during the calculation, lessening the effect of obtaining a steady state field in a short time by using the TP-EEC method. In the TDC method, since time harmonics are an obstacle to correction, if there are many time harmonics, correction power is lowered.

An object of the present invention is to provide a fast steady state field analysis method, a fast steady state field analysis apparatus, a fast steady state field analysis program, and a computer-readable recording medium storing its program, by which physical quantities of an analysis object in a steady state can be precisely obtained in a short time in transient analysis of a phenomenon including a time-derivative term.

### Solution to Problem

A feature of the present invention for attaining the above object, comprises of carrying out a first analysis in which a physical quantity of an analysis object is calculated by an analyzing apparatus through transient analysis based on an analysis executing module in which a differential equation including a time term is made discrete; correcting the calculated physical quantity by using a time harmonic order in a first correcting apparatus; and carrying out a second analysis after the correction of the physical quantity, in which a physical quantity of the analysis object in a steady state is calculated by using the analyzing apparatus through transient analysis based on the analysis executing module in which the differential equation including a time term is made discrete.

Since the physical quantity obtained through transient analysis of the analysis object is corrected in consideration of the time harmonic of the physical quantity of the analysis object, the physical quantity (steady state solution) of the analysis object in its steady state can be precisely obtained in a short time in transient analysis of a phenomenon including a time-derivative term.

It is desirable to calculate a time-averaged value of a plurality of physical quantities that are present in a set time width and are calculated in the first analysis by using a time averaging apparatus, and to carried out the correction of the physical quantity by the first correcting apparatus by using a time harmonic order that reflects the time averaged physical quantity.

Since the correction is carried out in consideration of a time-averaged physical quantity (time-averaged value of the calculated physical quantity of the analysis object), an effect on the correction by the use of a time harmonic (sub-harmonic) that is not considered in the correction can be reduced and the precision of the obtained steady state solution can be further improved.

### Advantageous Effect of the Invention

According to the present invention, the physical quantity of the analysis object in its steady state can be precisely obtained in a short time in transient analysis of a phenomenon including a time-derivative term.

### BRIEF DESCRIPTION OF THE DRAWINGS

FIG. 1 is a flowchart showing a processing procedure executed in a fast steady state field analysis method according to a first embodiment which is a preferred embodiment of the present invention.

FIG. 2 is a structural diagram showing a computer that executes a processing procedure shown in FIG. 1.

FIG. 3 is an explanatory drawing showing time varying changes of y in a numeric calculation example when a processing procedure shown in FIG. 1 is executed.

FIG. 4 is an explanatory drawing showing time varying changes in error with respect to a theoretical solution in a numeric calculation example when a processing procedure in shown FIG. 1 is executed.

FIG. 5 is a flowchart showing a processing procedure executed in a fast steady state field analysis method according to a second embodiment which is another embodiment of the present invention.

FIG. 6 is a flowchart showing a processing procedure executed in a fast steady state field analysis method according to a third embodiment which is another embodiment of the present invention.

FIG. 7 is a flowchart showing a processing procedure executed in a fast steady state field analysis method according to a fifth embodiment which is another embodiment of the present invention.

### DETAILED DESCRIPTION OF THE PREFERRED EMBODIMENTS

Embodiments of a fast steady state field analysis method of the present invention will be described in detail. In the embodiment of the fast steady state field analysis method of the present invention, calculations are performed in a plurality of time steps, and physical quantities of an analysis object are obtained through transient analysis based on a differential equation including a time-derivative term. The fast steady state field analysis method is executed by a computer, which is an operation apparatus, and analysis results are stored in a storage apparatus and displayed on a display apparatus.

### First Embodiment

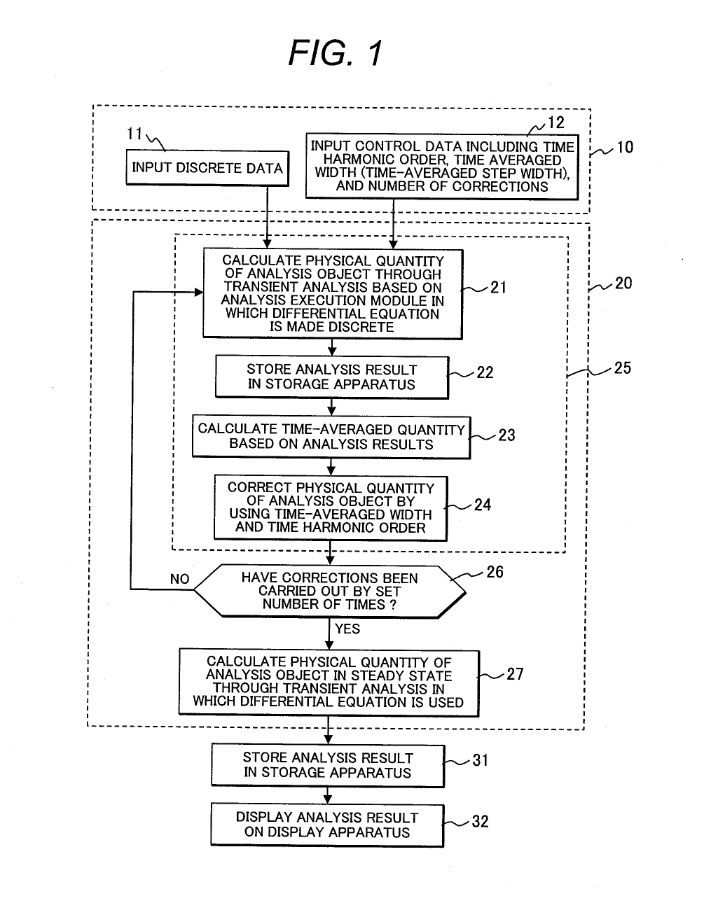

A fast steady state field analysis method in a first embodiment, which is a preferable embodiment of the present invention, will be described below with reference to FIG. 1.

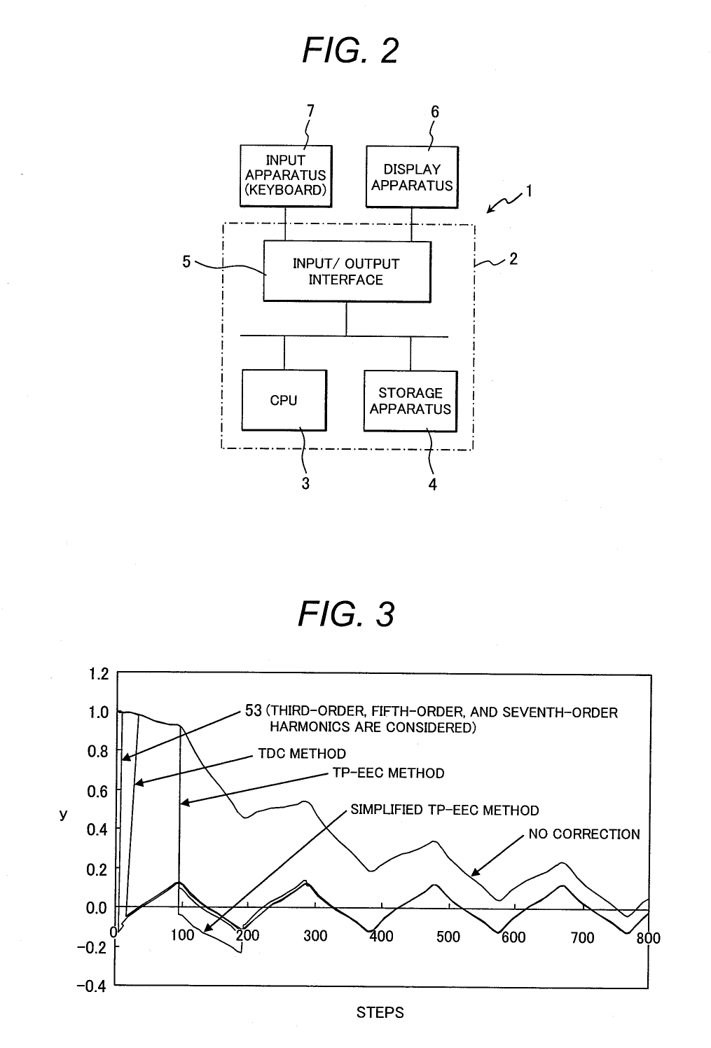

The fast steady state field analysis method of the present embodiment is executed by a computer 1, which is an operation apparatus, shown in FIG. 2. As shown in FIG. 2, the computer 1 has an operation apparatus 2, a display apparatus 6, and an input apparatus (for example, a keyboard or a mouse) 7. The operation apparatus 2 has a central processing unit (hereafter referred to as the CPU) 3, a storage apparatus 4, and an input/output interface 5. The CPU 3 is connected to the input/output interface 5, and the storage apparatus 4 is connected to the CPU 3 and the input/output interface 5. The display apparatus 6 and input apparatus 7 are connected to the input/output interface 5. The storage apparatus 4 stores in advance a processing procedure, shown in FIG. 1, executed in the fast steady state field analysis method, a differential equation including a time-derivative term, which is used to calculate physical quantities of a analysis object (for example, Maxwell's equations or their variations when electromagnetic field analysis is carried out), and control data used to control analysis processes. The control data includes the necessary number of corrections, and a time harmonic order used to correct the physical quantities calculated through analysis. The control data is stored in a data file in the storage apparatus 4. The processing procedure, shown in FIG. 1, executed by the fast steady state field analysis method is programmed as a program of the fast steady state field analysis method and is stored in advance in the storage apparatus 4. The storage apparatus 4 is a recording medium that can be read by the CPU 3.

The processing procedure in the fast steady state field analysis method, which is used in the present embodiment, includes a data input process 10, an analysis process 20, a process 31 for storing analysis result, and a display process 32. The fast steady state field analysis method, executed by the computer 1, in the present embodiment will be specifically described with reference to the processing procedure shown in FIG. 1.

When the computer 1 is set up to execute the fast steady state field analysis method and the operator enters information about an analysis object from the input apparatus 7, the CPU 3 reads out a program including the processing procedure shown in FIG. 1 and a differential equation used for the analysis from the storage apparatus 4, and stores the program and differential equation in an internal memory of the CPU 3. The CPU 3 also reads out the control data stored in the data file in the storage apparatus 4 and displays the control data on the display apparatus 6. The operator selects information necessary for analysis of interest from the control data displayed on the display apparatus 6. The CPU 3 inputs the selected control data (step 12). The selected control data is stored in an internal memory of the CPU 3. Specifically, when the operator selects with the mouse a value of the number of corrections, a time harmonic order used in the analysis, and a value of a time-averaged width (number of time-averaged steps) from the control data, displayed on the display apparatus 6, which includes the numbers of corrections, time harmonic orders, and time-averaged widths, the value of the selected number of corrections, the selected time harmonic order, and the value of the selected time-averaged width are stored into the internal memory of the CPU 3.

The operator further enters discrete data (mesh data) of the analysis object, which is used to numerically solve the differential equation, from the input apparatus 7. The CPU 3 inputs the discrete data (mesh data) of the analysis object, which is used to numerically solve the differential equation, through the input/output interface 5 (step 11) and stores the discrete data in the internal memory of the CPU 3. The control data may also be entered into the CPU 3 by the operator through a graphic user interface (GUI) or the like.

Upon completion of the data input process 10, the CPU 3 executes the processes of the analysis process 20. The analysis process 20 includes a correction process 25. The correction process 25 includes processes executed in steps 21 to 24. First, a first analysis is carried out in which the physical quantity of the analysis object is calculated through transient analysis based on an analysis execution module in which a differential equation is made discrete (step 21). The analysis execution module in which the differential equation is made discrete is created from the discrete data (mesh data) of the analysis object, which has been input in step 11. In the transient analysis in which the analysis execution module is used, the physical quantity of the analysis object is calculated for each time step (execution of the first analysis). A conventional known method is used to create the analysis execution module in which the differential equation is made discrete and to carry out the analysis based on the module. After the physical quantity of the analysis object has been calculated, the analysis result is stored in the storage apparatus 4 (step 22). The physical quantity of the analysis object, which has been obtained in step 21, is stored in the storage apparatus 4 for each time step.

A time-averaged value of the calculated physical quantity of the analysis object is calculated (step 23). Specifically, a time-averaged physical quantity of the analysis object is calculated based on the physical quantity of the analysis object, which has been calculated and stored in the storage apparatus 4, the calculated physical quantity being present in the time averaged width input in step 12. When the time-averaged physical quantity of the analysis object is obtained, the time harmonic components included in the physical quantity are averaged.

The physical quantity of the analysis object is corrected by using the time-averaged width and time harmonic order (step 24). Specifically, the physical quantity of the analysis object for each time step, which has been stored in storage apparatus 4, is corrected by using the time-averaged width and the time harmonic order, which have been input in step 12. The time-averaged physical quantity of the analysis object, obtained in step 23, is reflected in a correction equation in which the time-averaged width and time harmonic order are used.

The correction equation in which the time harmonic order is used will be described before the correction process in step 24 in the present embodiment is described.

In step 24, the calculated physical quantity of the analysis object is subjected to correction in which a basic wave and a time harmonic are extracted from the physical quantity of the analysis object, which is an analysis result in an initial non-steady state field, obtained in the analysis in step 21, and then the initial non-steady state field is replaced with the sum of the basis wave and the time harmonic. This correction is carried out once or a plurality of times.

One method of extracting the basic wave component and time harmonic component from the physical quantity of the analysis object, which is the analysis result in the initial non-steady state field, is to extract an approximate basic wave component and time harmonic component by performing Fourier expansion on an analysis result in a half period or one period. Alternatively, Fourier expansion may be carried out after damped components were approximately removed from the physical quantity of the analysis object, which is the analysis result in the initial non-steady state field.

To increase precision with which the basic wave component and time harmonic component are extracted, it is preferable to carry out a time-averaging process on the calculated physical quantity of the analysis object for the physical quantity of the analysis object which is an analysis result in an initial non-steady state field, within a certain time width, and to remove approximately time harmonic components that contribute to corrections only to a limited extent. In step 24 in the present embodiment, the correction equation using the time harmonic order for which the time-averaging process has been reflected is used. Of course, if such a time harmonic component is small or is not included, this averaging process is not necessary.

To perform Fourier expansion in the correction of the physical quantity of the analysis object, the analysis results of the physical quantity of the analysis object need to be in a half period or one period. In the correction in the present embodiment, which will be describe below, the basic wave and time harmonic are extracted from analysis results obtained in a time shorter than a half period to obtain the physical quantity of the analysis object in an substantially steady state field.

To simplify explanation, a description related to a one-variable field x(θ) is performed by using a time variable θ represented by an electrical angle. When a steady state field is half cyclic, that is, the condition x(θ+π)=−x(θ) is satisfied, the steady state field is constituted by only odd-order time harmonics. In view of the damping field of time constant τ, x(θ) is represented by, for example, equation (1).

$$x ( θ ) = {a}_{0} {e}^{- γθ} + {\sum }_{k = 1}^{p} {x}_{{n}_{k}} ( θ ) + {\sum }_{l \neq l} {x}_{l} ( θ ) \qquad ( 1 )$$

where a₀ is an initial value of the damping component term, xₙ is a time harmonic component to be considered, x₁ is a time harmonic component not to be considered, γ is reciprocal of the damping time constant of the damping component term. The third term in the right side of equation (1) indicates a time harmonic (sub-harmonic) other than the time harmonic with the entered time harmonic order. The variable θ is a time variable represented by an electric angle. To lessen the effect on correction of the sub-harmonic, equation (1) is time-averaged. If the time average field is assumed to be y=y(θ)=<x(θ)> and a phase width for time averaging is assumed to be 2φ, equation (1) can be approximately represented by equation (2).

$$y ( θ ) ≅ {a}_{0}^{′} {e}^{- γθ} + {\sum }_{k = 1}^{p} {y}_{{n}_{k}} ( θ ) \qquad ( 2 )$$

where yn(θ) can be represented by equation (3).

$${y}_{{n}_{k}} ( θ ) = 〈 {x}_{{n}_{k}} ( θ ) 〉 = ( \frac{sin {n}_{k} φ}{{n}_{k} φ} ) {x}_{{n}_{k}} ( θ - φ ) \qquad ( 3 )$$

where φ is a half of the value obtained by converting the time-averaged width to the phase width of the basic wave component. In a second embodiment described later, the effect on correction of time harmonics other than a main time harmonic is infinitesimal and the phase width 2φ for time averaging can be thereby considered to be 0. Accordingly, the same description as in the present embodiment is possible. If 2m-order time differentiation is applied to equation (3), equation (4) can be obtained.

$$\frac{{d}^{2 m} y ( θ )}{d {θ}^{2 m}} ≅ {\sum }_{k = 1}^{p} {( - )}^{m} {n}_{k}^{2 m} {y}_{{n}_{k}} ( θ ) \qquad ( 4 )$$

If time differentiation up to 2p order is used, the p number of simultaneous equations (m=1, 2, . . . , p) are given and the p number of values of the time harmonic yₙ_{ₖ}(θ) can be obtained. In view of equation (3), equation (5) is obtained as a time harmonic order correction equation used to obtain a steady state field of the original unknown quantity field x(θ).

$${x}^{new} ( θ - φ ) = {\sum }_{k = 1}^{p} {g}_{{n}_{k}} {y}_{{n}_{k}} ( θ ) , {g}_{{n}_{k}} = \frac{{n}_{k} φ}{sin {n}_{k} φ} \qquad ( 5 )$$

where x^{new} represents x after correction. To numerically obtain a time differential value of the 2p order, a value for (2p+1) steps needs to be used. When it is considered that a central difference is used to increase the calculation precision of numerical differentiation, it is necessary that the correction is performed from the p previous steps, besides φ, which is a half of the phase width used for averaging. Correction algorithms with time harmonics taken into consideration will be shown below for cases in which the number of time harmonics is 1, 2, and 3. For convenience, 2m-order differentiation of y(θ) will be represented as y^{(2m)} (θ).

A time harmonic order correction equation with one n-order time harmonic taken into consideration will be derived. Equation (2) can be represented as equation (6).

y(θ)=a′₀e^{-γθ}+y₁(θ)+yₙ(θ) (6)

The second-order differentiation and fourth-order differentiation in equation (6) can be respectively rewritten as equations (7) and (8).

y⁽²⁾(θ)−y₁(θ)−n²yₙ(θ) (7)

y⁽⁴⁾(θ)=y₁(θ)+n²yₙ(θ) (8)

If N=n², then equations (7) and (8) can be respectively rewritten as equations (9) and (10).

$$\begin{matrix}{y}_{1} ( θ ) = - \frac{{Ny}^{( 2 )} ( θ ) + {y}^{( 4 )} ( θ )}{N - 1} & ( 9 ) \\ {y}_{n} ( θ ) = \frac{{y}^{( 2 )} ( θ ) + {y}^{( 4 )} ( θ )}{N ( N - 1 )} & ( 10 )\end{matrix}$$

The time harmonic order correction equation with one n-order time harmonic taken into consideration can be represented as equation (11) by using equations (9) and (10).

x^{new}(θ−φ)=g₁y₁(θ)+gₙyₙ(θ) (11)

Next, a time harmonic order correction equation with one n-order time harmonic and one m-order time harmonic taken into consideration will be derived. Equation (2) can be rewritten as equation (12).

y(θ)=a′₀e^{-γθ}+y₁(θ)+yₙ(θ)+yₘ(θ) (12)

where a′₀ is the initial value of the damping component after time averaging. The second-order differentiation, fourth-order differentiation, and sixth-order differentiation in equation (12) can be respectively rewritten as equations (13), (14), and (15).

y⁽²⁾(θ)=−y₁(θ)−n²yₙ(θ)−m²yₘ(θ) (13)

y⁽⁴⁾(θ)=y₁(θ)+n⁴yₙ(θ)+m⁴yₘ(θ) (14)

y⁽⁶⁾(θ)=−y₁(θ)−n⁶yₙ(θ)−m⁶yₘ(θ) (15)

If N=n² and M=m², then equations (13), (14), and (15) can be respectively rewritten as equations (16), (17), and (18).

$$\begin{matrix}{y}_{1} ( θ ) = - \frac{{NMy}^{( 2 )} ( θ ) + ( N + M ) {y}^{( 4 )} ( θ ) + {y}^{( 6 )} ( θ )}{( N - 1 ) ( M - 1 )} & ( 16 ) \\ {y}_{n} ( θ ) = - \frac{{My}^{( 2 )} ( θ ) + ( M + 1 ) {y}^{( 4 )} ( θ ) + {y}^{( 6 )} ( θ )}{N ( N - 1 ) ( N - M )} & ( 17 ) \\ {y}_{m} ( θ ) = - \frac{{Ny}^{( 2 )} ( θ ) + ( N + 1 ) {y}^{( 4 )} ( θ ) + {y}^{( 6 )} ( θ )}{M ( M - 1 ) ( M - N )} & ( 18 )\end{matrix}$$

Equation (19) can be obtained by using equations (16), (17), and (18), equation (19) being a time harmonic order correction equation with one n-order time harmonic and one m-order time harmonic taken into consideration.

x^{new}(θ−φ)=g₁y₁(θ)+gₙyₙ(θ)+gₘyₘ(θ) (19)

Next, a time harmonic order correction equation with one n-order time harmonic, one m-order time harmonic, and one k-order time harmonic taken into consideration will be derived. Equation (2) can be rewritten as equation (20).

y(θ)=a′₀e^{-γθ}+y₁(θ)+yₙ(θ)+yₘ(θ)+yₖ(θ) (20)

The second-order differentiation, fourth-order differentiation, sixth-order differentiation, and eighth-order differentiation in equation (20) can be respectively rewritten as equations (21), (22), (23), and (24).

y⁽²⁾(θ)=−y₁(θ)−n²yₙ(θ)−m²yₘ(θ)−k²kₖ(θ) (21)

y⁽⁴⁾(θ)=y₁(θ)+n⁴yₙ(θ)+m⁴yₘ(θ)+k⁴yₖ(θ) (22)

y⁽⁶⁾(θ)=−y₁(θ)−n⁶yₙ(θ)−m⁶yₘ(θ)−k⁶yₖ(θ) (23)

y⁽⁸⁾(θ)=y₁(θ)+n⁸yₙ(θ)+m⁸yₘ(θ)+k⁸yₖ(θ) (24)

If N=n², M=m², and K=k², then equations (21), (22), (23), and (24) can be respectively rewritten as equations (25), (26), (27), and (28).

$$\begin{matrix}{y}_{1} ( θ ) = - \frac{\begin{matrix}{NMKy}^{( 2 )} ( θ ) + ( NM + MK + KN ) {y}^{( 4 )} ( θ ) + \\ ( N + M + K ) {y}^{( 6 )} ( θ ) + {y}^{( 8 )} ( θ )\end{matrix}}{( N - 1 ) ( M - 1 ) ( K - 1 )} & ( 25 ) \\ {y}_{n} ( θ ) = \frac{\begin{matrix}{MKy}^{( 2 )} ( θ ) + ( MK + M + K ) {y}^{( 4 )} ( θ ) + \\ ( M + K + 1 ) {y}^{( 6 )} ( θ ) + {y}^{( 8 )} ( θ )\end{matrix}}{N ( N - 1 ) ( N - M ) ( N - K )} & ( 26 ) \\ {y}_{m} ( θ ) = \frac{\begin{matrix}{KNy}^{( 2 )} ( θ ) + ( KN + K + N ) {y}^{( 4 )} ( θ ) + \\ ( K + N + 1 ) {y}^{( 6 )} ( θ ) + {y}^{( 8 )} ( θ )\end{matrix}}{M ( M - 1 ) ( M - K ) ( M - N )} & ( 27 ) \\ {y}_{k} ( θ ) = \frac{\begin{matrix}{NMy}^{( 2 )} ( θ ) + ( NM + N + M ) {y}^{( 4 )} ( θ ) + \\ ( N + M + 1 ) {y}^{( 6 )} ( θ ) + {y}^{( 8 )} ( θ )\end{matrix}}{K ( K - 1 ) ( K - N ) ( K - M )} & ( 28 )\end{matrix}$$

Equation (29) can be obtained by using equations (25), (26), (27), and (28), equation (29) being a time harmonic order correction equation with one n-order time harmonic, one m-order time harmonic, and one k-order time harmonic taken into consideration from equations (21).

x^{new}(θ−φ)=g₁y₁(θ)+gₙyₙ(θ)+gₘyₘ(θ)+gₖyₖ(θ) (29)

As described above, when the number of time harmonics is n, values for odd-numbered orders up to 2(n+1) can be used for correction.

Equations to numerically obtain second-order differentiation, fourth-order differentiation, sixth-order differentiation, and eighth-order differentiation will be shown below. In each differentiation, a central difference is used to increase the precision of the equation.

Differentiation equations in an s-th step can be written as equations (30), (31), (32), and (33).

$$\begin{matrix}{y}^{( 2 )} = \frac{{y}_{( s + 1 )} - 2 {y}_{( s )} + {y}_{( s - 1 )}}{{( Δθ )}^{2}} & ( 30 ) \\ {y}^{( 4 )} = \frac{{y}_{( s + 2 )} - 4 {y}_{( s + 1 )} + 6 {y}_{( s )} - 4 {y}_{( s - 1 )} + {y}_{( s - z )}}{{( Δθ )}^{4}} & ( 31 ) \\ {y}^{( 6 )} = \frac{\begin{matrix}{y}_{( s + 3 )} - 6 {y}_{( s + 2 )} + 15 {y}_{( s + 1 )} - 20 {y}_{( s )} + \\ 15 {y}_{( s - 1 )} - 6 {y}_{( s - 2 )} + {y}_{( s - 3 )}\end{matrix}}{{( Δθ )}^{6}} & ( 32 ) \\ {y}^{( 8 )} = \frac{\begin{matrix}{y}_{( s + 4 )} - 8 {y}_{( s + 3 )} + 28 {y}_{( s + 2 )} - 56 {y}_{( s + 1 )} + 70 {y}_{( s )} - \\ 56 {y}_{( s - 1 )} + 28 {y}_{( s - 2 )} - 8 {y}_{( s - 3 )} + {y}_{( s - 4 )}\end{matrix}}{{( Δθ )}^{8}} & ( 33 )\end{matrix}$$

As shown above, calculations over many time steps are necessary to obtain high-order differentiations. If too many time harmonics are considered, the number of time steps required for correction is increased accordingly. Therefore, too many time harmonics are disadvantageous in reducing a calculation time taken to carry out correction.

Assuming that a time-averaging process for the phase width 2φ related to the variable field x(θ) is equivalent to a time average between a time (s−q) step to a time (s+q) step, a time average y(s) can be represented by equation (34).

$${y}_{( s )} = \frac{1}{2 q + 1} {\sum }_{j = s - q}^{s + q} {x}_{j} \qquad ( 34 )$$

In this case, the value at time tₛ is corrected by using the value of x that was calculated until time t_{s+q}, so the correction needs to be executed at the time point q time steps before. If time averaging is not performed, in which case q is 0. In addition, when 2p-order time differentiation is calculated, the correction needs to be executed at the time point q time steps before. After all, the correction needs to be executed at the time point (q+p) time steps before. Even if the number of previous steps to be traced is not (q+p), a correction effect can be obtained accordingly, so the number of previous steps to be traced is not limited to (q+p).

In step 24 in the present embodiment, the physical quantity of the analysis object for each time step is corrected by using any one of the time harmonic order correction equations represented by equations (5), (11), (19), and (29). Which one of equations (5), (11), (19), and (29) is used as the time harmonic order correction equation in step 24 is determined when the operator selects a choice from the time harmonic order correction equations, represented by equations (5), (11), (19), and (29), displayed on the display apparatus 6 with the mouse in step 12. The time harmonic order correction equations, represented by (5), (11), (19), and (29), are time-averaging time harmonic order correction equations. In correction in step 24, the physical quantity of the analysis object for each time step, which has been stored in the storage apparatus 4 in step 22, is corrected by using the time-averaged width and time harmonic order, which have been input in step 12 according to the choice. The time-averaged physical quantity of the analysis object, which has been calculated in step 23, is reflected in the correction equation in which the time-averaged width and time harmonic order used in this correction are employed. Specifically, the time-averaged harmonic component of the calculation object, which is included in equation (5), is calculated by using the time-averaged physical quantity and its odd-numbered order time differential values.

Whether correction has been carried out a set number of times is determined (step 26). Specifically, whether the correction in step 24 has been carried out by the set number of corrections which has been input in step 12, is determined. If the determination result is “No”, each of the processes of steps 21-26 is carried out. If the determination result in step 26 is “Yes”, analysis in step 27 is executed.

A second analysis is carried out in which the physical quantity of the analysis object in a steady state is calculated through transient analysis in which a differential equation is used (step 27). After the correction in step 24, the physical quantity of the analysis object is placed physical quantity in a steady state. In step 27, the physical quantity of the analysis object in the steady state is calculated through the transient analysis in which the differential equation used in step 21 is employed (execution of a second analysis). In this transient analysis, the physical quantity of the analysis object in the steady state field in one period can be obtained for each time step.

The analysis result obtained in step 27 is stored (step 31). Specifically, the physical quantity of the analysis object in the steady state field for each step, which has been obtained in step 27, is stored by the CPU 3 in the storage apparatus 4. The analysis result is displayed on the display apparatus 6 (step 32). The CPU 3 outputs the physical quantity of the analysis object for each time step in the steady state, obtained through transient analysis carried out in step 27, to the display apparatus 6 through the input/output interface 5. As a result, the physical quantity of the analysis object, obtained for each time step in the steady state, is displayed on the display apparatus 6. In step 32, the CPU 3 outputs the physical quantity of the analysis object for each time step, which has been obtained through transient analysis carried out in step 21, and the physical quantity of the analysis object for each time step, which has been obtained through correction carried out in step 24, to the display apparatus 6 through the input/output interface 5. These physical quantities are displayed on the display apparatus 6. Since the physical quantity of the analysis object, obtained for each time step in the steady state, is a solution of analysis according to the fast steady state field analysis method of the present embodiment, the physical quantity must be surely displayed on the display apparatus 6. The physical quantity obtained through transient analysis in step 21 and the physical quantity obtained through correction in step 24 are displayed on the display apparatus 6 as necessary.

The inventors thought out a sample model targeted at simultaneous differential equations related to two variables, x and y, to prove a specific effect of correction in the present embodiment. As an example, a simultaneous differential equation, indicated as equation (35), in which third-order, fifth-order, and seventh-order time harmonics are present in the source term will be explained. Equations (5), (11), (19), and (29) are correction equations used to approximate the physical quantity calculated in step 21 to the value in the steady state field. Equation (35) is a sample differential equation (governing equation related to the physical quantity of the analysis object).

$$( \begin{matrix}2 & - 1 \\ - 1 & 2\end{matrix} ) ( \begin{matrix}x \\ y\end{matrix} ) + τ ( \begin{matrix}d x / d t \\ d y / d t\end{matrix} ) = ( \begin{matrix}0 \\ sin θ + \frac{1}{2} sin 3 θ + \frac{1}{4} sin 5 θ + \frac{1}{6} sin 7 θ\end{matrix} ) \qquad ( 35 )$$

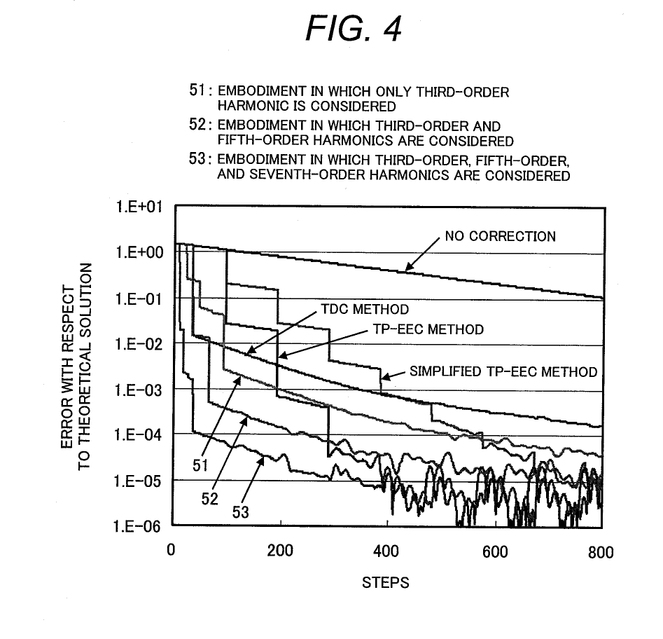

Analysis results obtained when x=0.1 and y=0.8 are set in equation (35) as initial values is shown in FIG. 3 and FIG. 4.

FIG. 3 illustrates time varying changes of y for five cases in which the physical quantity of the analysis object, obtained through transient analysis in step 21, was not corrected, was corrected by the simplified TP-EEC method, was corrected by the TP-EEC method, was corrected by the TDC method, and was corrected by the time harmonic order correction method, in the present embodiment, based on time averaging with three time harmonics taken into consideration (time-averaged time harmonic order) (characteristic 53). It can be appreciated from FIG. 3 that the correction in the present embodiment causes convergence to the steady state in the shortest time when compared to the conventional simplified TP-EEC method, TP-EEC method, and TDC method.

FIG. 4 illustrates time varying changes in error between the steady state theoretical solution and the corrected physical quantity for cases in which the physical quantity of the analysis object, obtained through transient analysis in step 21, was not corrected, was corrected by the simplified TP-EEC method, was corrected by the TP-EEC method, was corrected by the TDC method, and was corrected by using the time-averaged time harmonic orders in the present embodiment. As for the present embodiment, the drawing illustrates three examples in which correction was carried out by using time-averaging time harmonic orders with third-order time harmonics taken into consideration (characteristic 51), correction was carried out by using time-averaging time harmonic orders with third-order and fifth-order time harmonics taken into consideration (characteristic 52), and correction was carried out by using time-averaging time harmonic orders with third-order, fifth-order, and seventh-order time harmonics taken into consideration (characteristic 53). It can be appreciated from FIG. 4 that the correction in the present embodiment can obtain a steady state field in less time steps and causes smaller error in physical quantity between the steady state theoretical solution and the corrected physical quantity than in the cases in which correction was not carried out, correction was carried out by the simplified TP-EEC method, and correction was carried out by the TP-EEC method, that is, a precise physical quantity is obtained.

The computer 1, which executes the fast steady state field analysis method of the present embodiment, functions as a fast steady state field analysis apparatus. The computer 1 has an analyzing apparatus for executing step 21 (first analyzing apparatus), an analysis result input apparatus for executing steps 22 and 31 to store analysis results (calculated physical quantities) in the storage apparatus, a time calculating apparatus for executing step 23 (time averaging apparatus), a correcting apparatus for executing step 24 (first correcting apparatus), a determination apparatus for executing step 26, and an analyzing apparatus for executing step 27 (second analyzing apparatus). The analyzing apparatus for executing step 21 (first analyzing apparatus) and the analyzing apparatus for executing step 27 (second analyzing apparatus) may be combined into one analyzing apparatus.

According to the present embodiment, since the physical quantity obtained through transient analysis of the analysis object is corrected in consideration of the time harmonic of the physical quantity of the analysis object, the physical quantity (steady state solution) of the analysis object in its steady state can be precisely obtained in a short time in transient analysis of a phenomenon including a time-derivative term. Furthermore, since in the present embodiment, correction is carried out in consideration of a time-averaged physical quantity (time-averaged value of the calculated physical quantity of the analysis object) in particular, an effect on correction by the use of a time harmonic (sub-harmonic) that has a time harmonic order not included in the control data input in step 12 can be reduced, and thereby the precision of the obtained steady state solution can be further improved.

### Second Embodiment

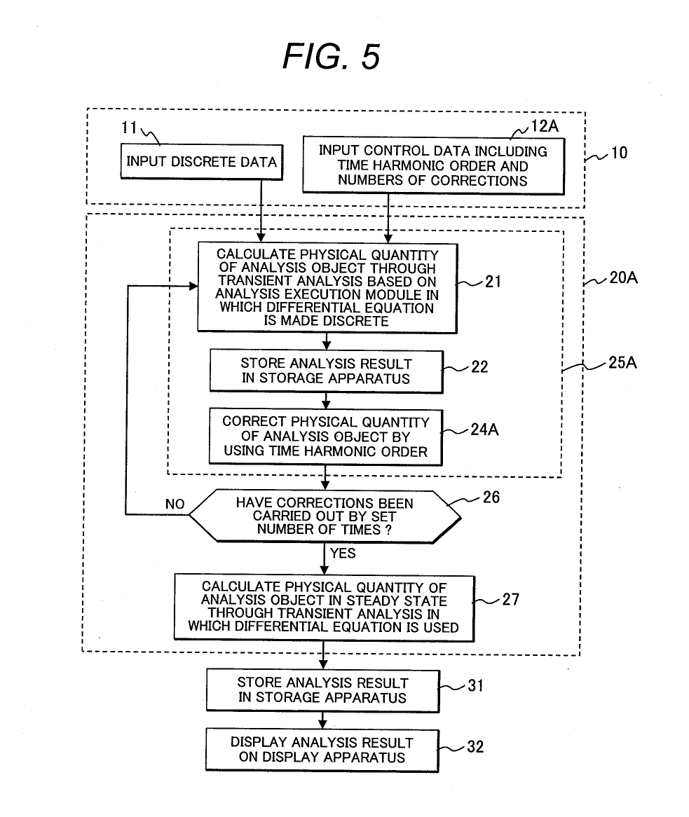

A fast steady state field analysis method according to a second embodiment which is another embodiment of the present invention will be described below with reference to FIG. 5. The fast steady state field analysis method of the present embodiment is also executed by the computer 1, which is an operation apparatus.

A processing procedure (program) for the fast steady state field analysis method of the present embodiment is executed by the computer 1. The processing procedure includes processes shown in FIG. 5, which are stored in the storage apparatus 4 in the computer 1. The processing procedure shown in FIG. 5, which is used in the present embodiment, is a processing procedure in which the process executed in the step 12, and analysis process 20 are respectively replaced with the process executed in step 12A, and an analysis process 20A in in the processing procedure shown in FIG. 1, which have been used in the first embodiment. The other processes in the processing procedure in FIG. 5, used in the present embodiment, are the same as in the processing procedure shown in FIG. 1, used in the first embodiment. The analysis process 20A includes a correction process 25A and processes executed in step 26 and 27. The correction process 25A has a processing procedure in which in the correction process 25, step 23 is removed and a process executed in step 24 is replaced with the process executed in step 24. The other processes in the correction process 25A are the same as in the correction process 25.

The fast steady state field analysis method of the present embodiment will be described mainly for differences from the first embodiment. In step 12A, the averaged time width, which has been input in step 12, is not input, but the number of corrections and a time harmonic order correction equation used in this analysis are input. Similarly to the first embodiment, the discrete data of the analysis object is input (step 11), the physical quantity of the analysis object is calculated through transient analysis (step 21), and the analysis results are stored in the storage apparatus (step 22).

The physical quantity of the analysis object is corrected by using a time harmonic order (step 24A). Specifically, the physical quantity of the analysis object, stored in the storage apparatus 4, for each time step is corrected by using the time harmonic order correction equation input in step 12A. The time harmonic order correction equation used in the correction in step 24A is a correction equation that uses any one of the time harmonic order equations, represented by equations (5), (11), (19), and (29), in which φ is set to 0. In step 24A, the calculated physical quantity of the analysis object for each time step is corrected by the correction equation that uses a time harmonic order, that is, by the basic wave and a time harmonic.

Each of the processes in steps 26, 27, 31, and 32 is then executed as in the first embodiment. In step 32, the physical quantity of the analysis object, obtained for each time step through transient analysis in step 27 after the steady state has been reached, is displayed on the display apparatus 6. The physical quantity obtained through transient analysis executed in step 21 and the physical quantity obtained by correction executed in step 24 are also displayed on the display apparatus 6.

The computer 1, which executes the fast steady state field analysis method of the present embodiment, functions as a fast steady state field analysis apparatus. The computer 1 has an analyzing apparatus for executing step 21 (first analyzing apparatus), an analysis result input apparatus for executing steps 22 and 31 to store analysis results (calculated physical quantities) in the storage apparatus, a correcting apparatus for executing step 24A (first correcting apparatus), a determination apparatus for executing step 26, and an analyzing apparatus for executing step 27 (second analyzing apparatus). The analyzing apparatus for executing step 21 (first analyzing apparatus) and the analyzing apparatus for executing step 27 (second analyzing apparatus) may be combined into one analyzing apparatus.

Since, in the present embodiment as well, as the first embodiment, the physical quantity obtained through transient analysis of the analysis object is corrected in consideration of the time harmonic of the physical quantity of the analysis object, the physical quantity (steady state solution) of the analysis object in its steady state can be precisely obtained in a short time in transient analysis of a phenomenon including a time-derivative term. Since, in the present embodiment, the correction is carried out without the time harmonic of the physical quantities of the analysis object being taken into consideration, the present embodiment takes a longer time to obtain the physical quantity (steady state solution) of the analysis object in its steady state than the first embodiment. If, however, the effect on correction of time harmonics other than the major time harmonic is infinitesimal, the physical quantity (steady state solution) of the analysis object in its steady state can be obtained in a short time, as in the first embodiment.

### Third Embodiment

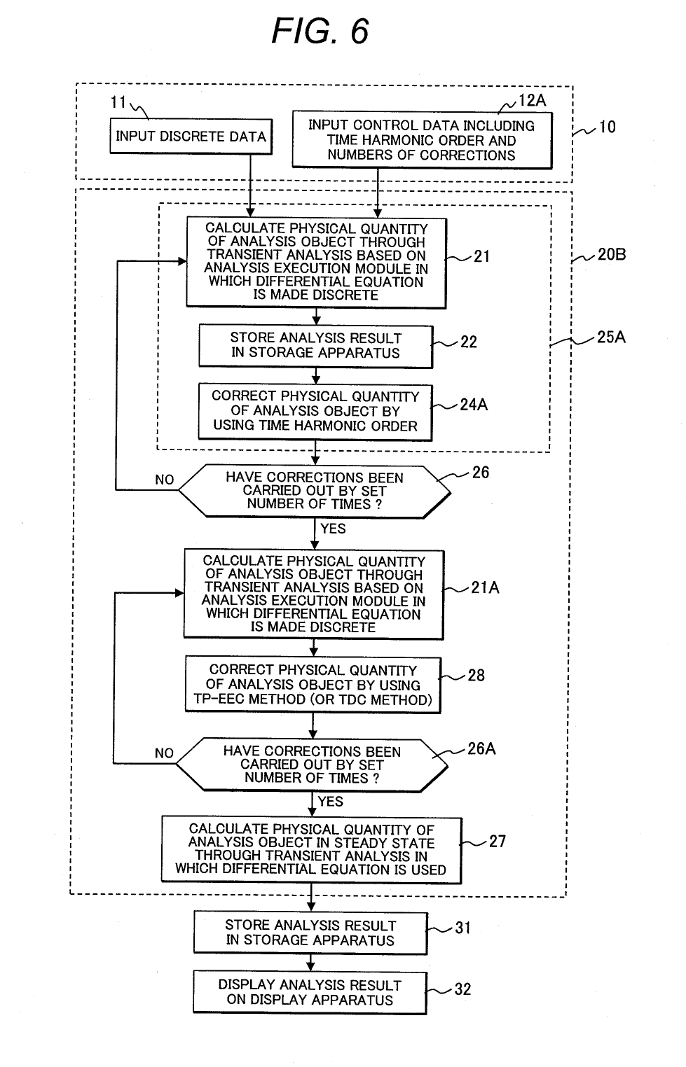

A fast steady state field analysis method according to a third embodiment which is another embodiment of the present invention will be described below with reference to FIG. 6. The fast steady state field analysis method of the present embodiment is also executed by the computer 1, which is an operation apparatus.

A processing procedure (program) for the fast steady state field analysis method of the present embodiment is executed by the computer 1. The processing procedure includes processes shown in FIG. 6, which are stored in the storage apparatus 4 in the computer 1. The processing procedure in FIG. 6, which is used in the present embodiment, is a processing procedure that in the analysis process 20A is replaced with an analysis process 20B in the processing procedure in FIG. 5, which has been used in the second embodiment. The other processes in the processing procedure in FIG. 6, used in the present embodiment, are the same as in the processing procedure in FIG. 5, used in the second embodiment. The analysis process 20B includes a processing procedure in which processes executed in steps 21A, 28, and 26A are added to the processing procedure of the analysis process 20A. The other processes in the processing procedure in the analysis process 20B are the same as in the analysis process 20A. In the fast steady state field analysis method of the present embodiment, the physical quantity of the analysis object is corrected by using the TDC method (or TP-EEC method) in step 28 in addition to correction by using a time harmonics order in step 24A in the fast steady state field analysis method in the second embodiment.

The fast steady state field analysis method of the present embodiment will be described mainly for differences from the second embodiment. In step 12A in the present embodiment, the number of corrections carried out in step 24A and the number of correction carried out in step 28 are input as the numbers of corrections. The sum of the number of corrections carried out in step 24A and the number of corrections carried out in step 28, the sum being input in step 12A in the present embodiment, is equal to the number of corrections carried out in step 24A, which is input in step 12A in the second embodiment.

As in the present embodiment, the processes executed in steps 21, 22, and 24A in the second embodiment are executed.

When it is determined in step 26 that the number of corrections carried out in step 24A reaches the number of corrections that has been input in step 12A in the present embodiment, a third analysis is carried out in which the physical quantity of the analysis object is calculated through transient analysis similar to transient analysis in step 21 (step 21A). In step 21A, the physical quantity of the analysis object after the time step at which correction has been carried out in step 24A is calculated through transient analysis in which the analysis execution module used in step 21 is employed (execution of the third analysis). The calculated physical quantity of the analysis object is corrected by using the TP-EEC method (or TDC method) (step 28). Specifically, the physical quantity of the analysis object obtained in step 21A for each time step is corrected by using the TP-EEC method (or TDC method) in which high-order differentiation is not included.

Whether the correction has been carried out a set number of times is determined (step 26A). Specifically, whether the correction in step 28 has been carried out by the number of corrections targeted at step 28, which has been input in step 12, is determined. When the determination result is “No”, the processes in steps 21A, 28, and 26A are repeated. When the determination result in step 26A is “Yes”, analysis in step 27 (second analysis) is carried out. Upon completion of the analysis in step 27, the processes in steps 31 and 32 are executed as in the second embodiment.

In step 32, the physical quantity of the analysis object, obtained for each time step through transient analysis in step 27A after the steady state has been reached, is displayed on the display apparatus 6 for each time step. The physical quantity obtained through transient analysis executed in step 21 and the physical quantity obtained by correction executed in step 24 are also displayed on the display apparatus 6.

The computer 1, which executes the fast steady state field analysis method of the present embodiment, functions as a fast steady state field analysis apparatus. The computer 1 has an analyzing apparatus for executing steps 21 and 21A (first analyzing apparatus), an analysis result input apparatus for executing steps 22 and 31 to store analysis results (calculated physical quantities) in the storage apparatus, a correcting apparatus for executing step 24A (first correcting apparatus), a determination apparatus for executing step 26 (first determination apparatus), a correcting apparatus for executing step 28 (second correcting apparatus), a determination apparatus for executing step 26A (second determination apparatus), and an analyzing apparatus for executing step 27 (second analyzing apparatus). The analyzing apparatus for executing steps 21 and 21A (first analyzing apparatus) and the analyzing apparatus for executing step 27 (second analyzing apparatus) may be combined into one analyzing apparatus. Since, in the present embodiment as well, as in the first embodiment, the physical quantity obtained through transient analysis of the analysis object is corrected in consideration of the time harmonic of the physical quantity of the analysis object, the physical quantity (steady state solution) of the analysis object in its steady state can be precisely obtained in a short time in transient analysis of a phenomenon including a time-derivative term. According to the present embodiment, fast correction with time harmonics taken into consideration is first carried out, and after an approximate steady state field has been obtained, steady state solutions can be obtained in a short time by correction carried out by using the TP-EEC method (or TDC method) in which high-order harmonics are not included.

In the present embodiment, the process in step 23 in the first embodiment may be added and steps 12A and 24A may be respectively replaced with steps 12 and 24. Then, in the present embodiment as well, correction with time-averaged quantities taken into consideration can be carried out.

### Fourth Embodiment

A fast steady state field analysis method according to a second embodiment which is another embodiment of the present invention will be described below. The present embodiment is an example in which the fast steady state field analysis method in the first embodiment is applied to magnetic field analysis.

A finite element method in which magnetic vector potential is used will be described as a typical analysis method. In a finite element method using node elements, unknown variables (Axj, Ayj, Azj) for three vector components are placed at each node in a mesh-divided analysis space. In a finite element method using edge elements, an unknown variable aj is placed on a side of each element in a mesh-divided analysis space. The unknown variable aj in the side element finite element method is a line integral quantity, on the side, of a projected component of the magnetic vector potential on the side of each element.

Unknown variables for these physical quantities are corrected in a way similar to the correction carried out for the physical quantity x of the analysis object in the first embodiment. That is, the correction in which any one of the time-averaged time harmonic order equations, represented by equations (5), (11), (19), and (29) input in step 12, is used is carried out for each unknown variable by using the transient analysis result obtained in step 21 (physical quantity x of the analysis object). This correction is carried out once or a plurality of times. In a series of corrections, any one of the time-averaged time harmonic order equations may be used or a combination of different equations may be used.

As for the stator of a rotating machine such as a motor or power generator, a generated electromagnetic field is an alternate current field in which the direction of the magnetic field is reversed between the positive pole and the negative pole, so a half period boundary condition holds. As for the rotor, magnets and exciting coils in which current flows may be provided. In this case, a direct current (DC) component of the magnetic field is present. Due to magnetic circuit variations caused by the rotation of the rotor, slot harmonics are present in the DC component of the magnetic field of the rotor, the slot harmonics being generated by the rotational movement of slots among a plurality of gear teeth. Therefore, a magnetic field in which the alternate current component is superimposed on the DC component is generated in the rotor, preventing a half period boundary condition from holding; in the rotor, only one period boundary condition holds.

In magnetic field analysis of a rotor of this type, therefore, if correction suiting the half period boundary condition is carried out for the stator and correction suiting the one period boundary condition is carried out for the rotor, a steady state field can be quickly obtained. Since the slot harmonics existing in the magnetic field of the rotor are just a small variation, even if correction is carried out only for the stator without correction for the rotor, a steady state field can be obtained in a sufficiently fast manner.

As for an induction motor rotationally driven by eddy current, the rotor rotates at a slow rotational frequency in the rotating magnetic field. A difference in frequency is referred to as the slip frequency. The slip frequency component is corrected as the basic frequency to quickly obtain a steady state field in an induction motor.

In the present embodiment, in which the fast steady state field analysis method of the first embodiment is applied to magnetic field analysis, a magnetic field distribution close to a steady state field can be obtained, and a calculation time taken to obtain convergence to the steady state can be significantly shortened. The Correction can be easily carried out by using, for example, a second-order differential value related to time of time-averaged quantities, and almost no calculation cost is incurred.

In magnetic field analysis involving eddy current, it is effective to start preparation calculation for correction after a certain number of halt steps has passed to have the field settled to some extent and, after the correction, to carry out preparation calculation for next correction after a certain number of halt steps has passed. In this case, include the number of halt steps in the input data.

The present embodiment, in which the fast steady state field analysis method in the first embodiment is applied to magnetic field analysis, can be obtained the effects generated in the first embodiment.

All of the embodiments 2 and 3 described above and a fifth embodiment described later can be applied to magnetic field analysis.

### Fifth Embodiment

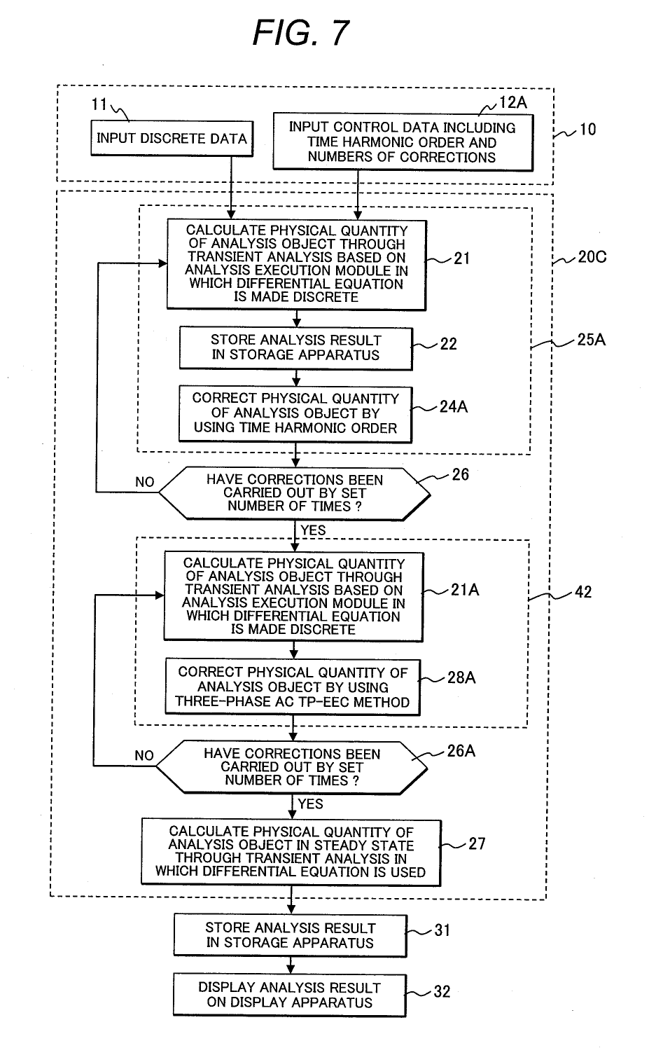

A fast steady state field analysis method according to a fifthe embodiment which is another embodiment of the present invention will be described below with reference to FIG. 7. The fast steady state field analysis method in the present embodiment is also executed by the computer 1, which is an operation apparatus.

A processing procedure (program) for the fast steady state field analysis method of the present embodiment is executed by the computer 1 and includes processes shown in FIG. 7, which are stored in the storage apparatus 4 in the computer 1. The processing procedure shown in FIG. 7, which is used in the present embodiment is a processing procedure that the analysis process 20B is replaced with an analysis process 20C in the processing procedure shown in FIG. 6, which has been used in the third embodiment. The other processes in the processing procedure shown in FIG. 7, used in the present embodiment, are the same as in the processing procedure shown in FIG. 6, used in the third embodiment. The analysis process 200 has a processing procedure in which step 28 in the analysis process 20B is replaced with step 28A. The other processes in the processing procedure in the analysis process 20C are the same as in the processing procedure 20B. In the fast steady state field analysis method of the present embodiment, the physical quantity of the analysis object is corrected by a three-phase alternate current TP-EEC method in step 28A instead of the TDC method (or TP-EEC method) in step 28 in the third embodiment. The correction process 42 includes the processes in steps 21A and 28A.

The fast steady state field analysis method of the present embodiment, in which a three-phase alternate current TP-EEC method is applied, will be described mainly for differences from the third embodiment.

When a three-phase alternate current TP-EEC method is used for correction, the physical quantity of the analysis object, which is calculated through transient analysis based on an analysis execution module in which a differential equation is made discrete, in step 21, is physical quantities U, V, and W of three phases, each of which has a phase difference of 120°. The process in step 22 is executed and correction is carried out in step 24A by using a time harmonic order. Since, in the present embodiment, the physical quantities U, V, and W of three phases are calculated in the first analysis in step 21, correction in step 24A is executed for each of the physical quantities U, V, and W of three phases. The time harmonic order correction equation used for correction of these physical quantities is any one of equations (5), (11), (19), and (29). When the physical quantity U is corrected, however, x is replaced with U in any one of equations (5), (11), (19), and (29). When the physical quantity V is corrected, however, x is replaced with V in any one of equations (5), (11), (19), and (29). When the physical quantity W is corrected, x is replaced with W in any one of equations (5), (11), (19), and (29). In this way, the physical quantities U, V, and W calculated for each time step in step 21 are corrected in step 24A.

When the determination result in step 26 becomes “Yes”, the physical quantities U, V, and W of three phases are calculated, respectively, in step 21A as well, for each time step after the time step of the last physical quantity calculated through transient analysis in step 21 (execution of the third analysis). In step 28A, the physical quantities U, V, and W of three phases, which have been calculated in step 21A, are corrected by the three-phase TP-EEC method, respectively.

A specific example of correction based on the three-phase TP-EEC method will be described below.

Suppose that the physical quantities U, V, and W of three phases, each of which has a phase difference of 120°, change from U₀, V₀, and W₀ to Uₙ, Vₙ, and Wₙ one-sixth period later. U^{new} obtained by correcting U, V^{new} obtained by correcting V, and W^{new} obtained by correcting W are respectively represented by equations (36), (37), and (38).

$$\begin{matrix}{U}^{new} = \frac{1}{2} ( d U + d V - d W ) & ( 36 ) \\ {V}^{new} = \frac{1}{2} ( d V + d W - d U ) & ( 37 ) \\ {W}^{new} = \frac{1}{2} ( d W + d U - d V ) & ( 38 )\end{matrix}$$

where dU, dV, and dW are represented by equation (39).

dU=Uₙ−U₀, dV=Vₙ−V₀, dW=Wₙ−W₀ (39)

Also suppose that Z of the three phases is −W and that the physical quantities U, Z, and V of three phases, each of which has a phase difference of 60°, change from U₀, Z₀, and W₀ to Uₙ, Zₙ, and Wₙ one-sixth period later. U^{new} obtained by correcting U, V^{new} obtained by correcting V, and W^{new} obtained by correcting W are respectively represented by equations (40), (41), and (42).

$$\begin{matrix}{U}^{new} = \frac{1}{2} ( d U + d Z + d V ) & ( 40 ) \\ {U}^{new} = \frac{1}{2} ( d U + d Z + d V ) & ( 40 ) \\ {V}^{new} = \frac{1}{2} ( d V - d U - d Z ) & ( 42 )\end{matrix}$$

where dU, dV, and dW are represented by equation (43).

dU=Uₙ−U₀, dZ=Zₙ−Z₀, dV=Vₙ−V₀ (43)

In step 28A, the physical quantities U, V, and W of three phases, which have been calculated in step 21A, are corrected by using equations (36), (37), and (38) (or equations (40), (41), and (42)). Equations (36), (37), and (38) and equations (40), (41), and (42) in step 28A are selectively used as described below. In a three-phase alternate current system of a one-period boundary model (U, V, W system), equations (36), (37), and (38) are used for correction in step 28A. In a three-phase alternate current system of a half-period boundary model (U, Z, V system (Z=−W)), equations (40), (41), and (42) are used for correction in step 28A.

When the determination result in step 26A is “Yes”, analysis in step 27 (second analysis) is carried out. Upon completion of analysis in step 27, the processes in steps 31 and 32 are executed as in the third embodiment.

The present embodiment can be obtained the effects generated in the second embodiment.

The computer 1, which executes the fast steady state field analysis method of the present embodiment, functions as a fast steady state field analysis apparatus. The computer 1 has an analyzing apparatus for executing steps 21 and 21A (first analyzing apparatus), an analysis result input apparatus for executing steps 22 and 31 to store analysis results (calculated physical quantities) in the storage apparatus, a correcting apparatus for executing step 24A (first correcting apparatus), a determination apparatus for executing step 26 (first correcting apparatus), a correcting apparatus for executing step 28A (second correcting apparatus), a determination apparatus for executing step 26A (second correcting apparatus), and an analyzing apparatus for executing step 27 (second analyzing apparatus). The analyzing apparatus for executing steps 21 and 21A (first analyzing apparatus) and the analyzing apparatus for executing step 27 (second analyzing apparatus) may be combined into one analyzing apparatus.

In the present embodiment, a TDC method may be used to correct the physical quantities U, V, and W in step 24A. Even if correction is carried out by the TDC method in this way, correction in step 28A is carried out by the TP-EEC method (or three-phase alternate current TP-EEC method).

As described above, even if the use of only the TDC method is insufficient to obtain the steady state solutions of the physical quantities of the analysis object, the steady state solutions can be precisely obtained by additionally carrying out correction by the TP-EEC method (or three-phase alternate current TP-EEC method) after correction by the TDC method.

Although, in the present embodiment, the three-phase alternate current TP-EEC method is used to correct the physical quantities of the analysis object in a three-phase alternate current system, it will be appreciated that a polyphase alternate current TP-EEC method is applicable in a polyphase alternate current system.

### REFERENCE SIGNS LIST

1: computer, 2: operation apparatus, 3: central processing unit, 4: storage apparatus, 5: input/output interface, 6: display apparatus, 7: input apparatus.

What is claimed is:

1. A fast steady state field analysis method, comprising steps of:
carrying out a first analysis in which a physical quantity of a analysis object is calculated by an analyzing apparatus through transient analysis based on an analysis executing module in which a differential equation including a time term is made discrete;
correcting the calculated physical quantity by using a time harmonic order in a first correcting apparatus; and
carrying out a second analysis after the correction of the physical quantity, in which a physical quantity of the analysis object in a steady state is calculated by using the analyzing apparatus through transient analysis based on the analysis executing module in which the differential equation including a time term is made discrete.

2. The fast steady state field analysis method according to claim 1, wherein a time-averaged value of a plurality of physical quantities that are present in a set time width and are calculated in the first analysis is calculated by using a time averaging apparatus; and
correction of the physical quantity by the first correcting apparatus is carried out by using the time harmonic order that reflects the time averaged value.

3. The fast steady state field analysis method according to claim 1, wherein a first determination apparatus determines whether correction of the physical quantity by the first correcting apparatus is carried out a first set number of times;
wherein when the correction of the physical quantity by the first correcting apparatus is carried out the first set number of times, a third analysis calculating the physical quantity of the analysis object in time steps after a time step in which the physical quantity is corrected at last by the first correcting apparatus, is carried out by using the analyzing apparatus;
wherein after the correction of the physical quantity by the first correcting apparatus is carried out the first set number of times, the physical quantity of the analysis object calculated in the third analysis, is corrected by using TP-EEC method in a second correcting apparatus; and
wherein when the correction of the physical quantity by the second correcting apparatus was carried out a second set number of times, a physical quantity in the steady state is calculated in the second analysis.

4. The fast steady state field analysis method according to claim 1, wherein a first determination apparatus determines whether the correction of the physical quantity was carried out a first set number of times by the first correcting apparatus;
wherein when the correction of the physical quantity was carried out the first set number of times by the first correcting apparatus, a third analysis calculating the physical quantity of the analysis object in time steps after a time step in which the physical quantity was corrected at last by the first correcting apparatus, is carried out by using the analyzing apparatus;
wherein after the correction of the physical quantity was carried out the first set number of times by the first correcting apparatus, the physical quantity of the analysis object calculated in the third analysis, is corrected by using a TDC method in a second correcting apparatus; and
wherein when correction of the physical quantity was carried out a second set number of times by the second correcting apparatus, a physical quantity in the steady state is calculated in the second analysis.

5. The fast steady state field analysis method according to claim 1, wherein a first determination apparatus determines whether the correction of the physical quantity was carried out a first set number of times by the first correcting apparatus;
wherein when the correction of the physical quantity was carried out the first set number of times by the first correcting apparatus, a third analysis calculating the physical quantity of the analysis object in time steps after a time step in which the physical quantity was corrected at last by the first correcting apparatus, is carried out by using the analyzing apparatus;
wherein after the correction of the physical quantity was carried out the first set number of times by the first correcting apparatus, the physical quantity of the analysis object calculated in the third analysis, is corrected by using a polyphase alternate current TP-EEC method in a second correcting apparatus; and
wherein when the correction of the physical quantity was carried out a second set number of times by the second correcting apparatus, a physical quantity in the steady state is calculated in the second analysis.

6. The fast steady state field analysis method according to claim 1, wherein when the correction of the physical quantity was carried out a set number of times by the first correcting apparatus, the physical quantity in the steady state is calculated in the second analysis.

7. A fast steady state field analysis apparatus, comprising:
an analyzing apparatus for carrying out a first analysis in which a physical quantity of a analysis object is calculated through transient analysis based on an analysis executing module in which a differential equation including a time term is made discrete; and
a first correcting apparatus for correcting the calculated physical quantity by using a time harmonic order;
the analyzing apparatus for carrying out a second analysis calculating a physical quantity of the analysis object in a steady state through transient analysis based on the analysis executing module in which the differential equation including a time term is made discrete, after the correction of the physical quantity.

8. The fast steady state field analysis apparatus according to claim 7, comprising:
a time averaging apparatus for calculating a time-averaged value of the physical quantity by using a plurality of physical quantities that are present in a set time width and are calculated in the first analysis; and
the first correcting apparatus for carrying out the correction of the physical quantity by using the time harmonic order that reflects the time averaged value.

9. The fast steady state field analysis apparatus according to claim 7, comprising:
a first determination apparatus for determining whether the correction of the physical quantity is carried out a first set number of times by the first correcting apparatus;
the analyzing apparatus for carrying out a third analysis in which the physical quantity of the analysis object in time steps after a time step in which the physical quantity is corrected at last by the first correcting apparatus is calculated when the correction of the physical quantity is carried out the first set number of times by the first correcting apparatus;
a second correcting apparatus for correcting the physical quantity of the analysis object calculated in the third analysis by using TP-EEC method after the correction of the physical quantity is carried out the first set number of times by the first correcting apparatus; and
the analyzing apparatus for calculating a physical quantity in the steady state in the second analysis when the correction of the physical quantity is carried out a second set number of times by the second correcting apparatus.

10. The fast steady state field analysis apparatus according to claim 7, comprising:
a first determination apparatus for determining whether the correction of the physical quantity is carried out a first set number of times by the first correcting apparatus;
the analyzing apparatus for carrying out a third analysis in which the physical quantity of the analysis object in time steps after a time step in which the physical quantity is corrected at last by the first correcting apparatus is calculated when the correction of the physical quantity is carried out the first set number of times by the first correcting apparatus;
a second correcting apparatus for correcting the physical quantity of the analysis object calculated in the third analysis by using a TDC method after the correction of the physical quantity is carried out the first set number of times by the first correcting apparatus; and
the analyzing apparatus for calculating a physical quantity in the steady state in the second analysis when the correction of the physical quantity is carried out a second set number of times by the second correcting apparatus.

11. The fast steady state field analysis apparatus according to claim 7, comprising:
a first determination apparatus for determining whether the correction of the physical quantity is carried out a first set number of times by the first correcting apparatus;
the analyzing apparatus for carrying out a third analysis in which the physical quantity of the analysis object in time steps after a time step in which the physical quantity is corrected at last by the first correcting apparatus is calculated when the correction of the physical quantity is carried out the first set number of times by the first correcting apparatus;
a second correcting apparatus for correcting the physical quantity of the analysis object calculated in the third analysis by using a polyphase alternate current TP-EEC method after the correction of the physical quantity is carried out the first set number of times by the first correcting apparatus; and
the analyzing apparatus for calculating a physical quantity in the steady state in the second analysis when the correction of the physical quantity is carried out a second set number of times by the second correcting apparatus.

12. The fast steady state field analysis apparatus according to claim 7, comprising:
the analyzing apparatus for calculating the physical quantity in the steady state when the correction of the physical quantity by the first correcting apparatus is carried out a set number of times in the second analysis.

13. A fast steady state field analysis program that commands a computer to carry out fast steady state field analysis by causing the computer to function as:
an analyzing apparatus for carrying out a first analysis in which a physical quantity of a analysis object is calculated through transient analysis based on an analysis executing module in which a differential equation including a time term is made discrete; and
a first correcting apparatus for correcting the calculated physical quantity by using a time harmonic order;
the analyzing apparatus for carrying out a second analysis calculating a physical quantity of the analysis object in a steady state through transient analysis based on the analysis executing module in which the differential equation including a time term is made discrete, after the correction of the physical quantity.

14. The fast steady state field analysis program according to claim 13, the program causing the computer to function as:
a time averaging apparatus for calculating a time-averaged value of the physical quantity by using a plurality of physical quantities that are present in a set time width and are calculated in the first analysis; and
the first correcting apparatus for carrying out the correction of the physical quantity by using the time harmonic order that reflects the time averaged value.

15. The fast steady state field analysis program according to claim 13, the program causing the computer to function as:
a first determination apparatus for determining whether the correction of the physical quantity is carried out a first set number of times by the first correcting apparatus;
the analyzing apparatus for carrying out a third analysis in which the physical quantity of the analysis object in time steps after a time step in which the physical quantity is corrected at last by the first correcting apparatus is calculated when the correction of the physical quantity is carried out the first set number of times by the first correcting apparatus;
a second correcting apparatus for correcting the physical quantity of the analysis object calculated in the third analysis by using TP-EEC method after the correction of the physical quantity is carried out the first set number of times by the first correcting apparatus; and
the analyzing apparatus for calculating a physical quantity in the steady state in the second analysis when the correction of the physical quantity is carried out a second set number of times by the second correcting apparatus.

16. The fast steady state field analysis program according to claim 13, the program causing the computer to function as:
a first determination apparatus for determining whether the correction of the physical quantity is carried out a first set number of times by the first correcting apparatus;
the analyzing apparatus for carrying out a third analysis in which the physical quantity of the analysis object in time steps after a time step in which the physical quantity is corrected at last by the first correcting apparatus is calculated when the correction of the physical quantity is carried out the first set number of times by the first correcting apparatus;
a second correcting apparatus for correcting the physical quantity of the analysis object calculated in the third analysis by using a TDC method after the correction of the physical quantity is carried out the first set number of times by the first correcting apparatus; and
the analyzing apparatus for calculating a physical quantity in the steady state in the second analysis when the correction of the physical quantity is carried out a second set number of times by the second correcting apparatus.

17. The fast steady state field analysis program according to claim 13, the program causing the computer to function as:
a first determination apparatus for determining whether the correction of the physical quantity is carried out a first set number of times by the first correcting apparatus;
the analyzing apparatus for carrying out a third analysis in which the physical quantity of the analysis object in time steps after a time step in which the physical quantity is corrected at last by the first correcting apparatus is calculated when the correction of the physical quantity is carried out the first set number of times by the first correcting apparatus;
a second correcting apparatus for correcting the physical quantity of the analysis object calculated in the third analysis by using a polyphase alternate current TP-EEC method after the correction of the physical quantity is carried out the first set number of times by the first correcting apparatus; and
the analyzing apparatus for calculating a physical quantity in the steady state in the second analysis when the correction of the physical quantity is carried out a second set number of times by the second correcting apparatus.

18. The fast steady state field analysis program according to claim 13, the program causing the computer to function as:
the analyzing apparatus for calculating the physical quantity in the steady state when the correction of the physical quantity by the first correcting apparatus is carried out a set number of times in the second analysis.

19. A computer-readable recording medium storing a fast steady state field analysis program that commands a computer to carry out fast steady state field analysis by causing the computer to function as:
an analyzing apparatus for carrying out a first analysis in which a physical quantity of a analysis object is calculated through transient analysis based on an analysis executing module in which a differential equation including a time term is made discrete; and
a first correcting apparatus for correcting the calculated physical quantity by using a time harmonic order;
the analyzing apparatus for carrying out a second analysis calculating a physical quantity of the analysis object in a steady state through transient analysis based on the analysis executing module in which the differential equation including a time term is made discrete, after the correction of the physical quantity.

20. The computer-readable recording medium according to claim 19, the computer-readable recording medium storing the program causing the computer to function as:
a time averaging apparatus for calculating a time-averaged value of the physical quantity by using a plurality of physical quantities that are present in a set time width and are calculated in the first analysis; and
the first correcting apparatus for carrying out the correction of the physical quantity by using the time harmonic order that reflects the time averaged value.

21. The computer-readable recording medium according to claim 19, the computer-readable recording medium storing the program causing the computer to function as:
a first determination apparatus for determining whether the correction of the physical quantity is carried out a first set number of times by the first correcting apparatus;
the analyzing apparatus for carrying out a third analysis in which the physical quantity of the analysis object in time steps after a time step in which the physical quantity is corrected at last by the first correcting apparatus is calculated when the correction of the physical quantity is carried out the first set number of times by the first correcting apparatus;
a second correcting apparatus for correcting the physical quantity of the analysis object calculated in the third analysis by using TP-EEC method after the correction of the physical quantity is carried out the first set number of times by the first correcting apparatus; and
the analyzing apparatus for calculating a physical quantity in the steady state in the second analysis when the correction of the physical quantity is carried out a second set number of times by the second correcting apparatus.

22. The computer-readable recording medium according to claim 19, the computer-readable recording medium storing the program causing the computer to function as:
a first determination apparatus for determining whether the correction of the physical quantity is carried out a first set number of times by the first correcting apparatus;
the analyzing apparatus for carrying out a third analysis in which the physical quantity of the analysis object in time steps after a time step in which the physical quantity is corrected at last by the first correcting apparatus is calculated when the correction of the physical quantity is carried out the first set number of times by the first correcting apparatus;
a second correcting apparatus for correcting the physical quantity of the analysis object calculated in the third analysis by using a TDC method after the correction of the physical quantity is carried out the first set number of times by the first correcting apparatus; and
the analyzing apparatus for calculating a physical quantity in the steady state in the second analysis when the correction of the physical quantity is carried out a second set number of times by the second correcting apparatus.

23. The computer-readable recording medium according to claim 19, the computer-readable recording medium storing the program causing the computer to function as:
a first determination apparatus for determining whether the correction of the physical quantity is carried out a first set number of times by the first correcting apparatus;
the analyzing apparatus for carrying out a third analysis in which the physical quantity of the analysis object in time steps after a time step in which the physical quantity is corrected at last by the first correcting apparatus is calculated when the correction of the physical quantity is carried out the first set number of times by the first correcting apparatus;
a second correcting apparatus for correcting the physical quantity of the analysis object calculated in the third analysis by using a polyphase alternate current TP-EEC method after the correction of the physical quantity is carried out the first set number of times by the first correcting apparatus; and
the analyzing apparatus for calculating a physical quantity in the steady state in the second analysis when the correction of the physical quantity is carried out a second set number of times by the second correcting apparatus.

24. The computer-readable recording medium according to claim 19, the computer-readable recording medium storing the program causing the computer to function as:
the analyzing apparatus for calculating the physical quantity in the steady state when the correction of the physical quantity by the first correcting apparatus is carried out a set number of times in the second analysis.

25. The fast steady state field analysis method according to claim 1, wherein the physical quantity in the steady state, calculated in the second analysis is displayed on a display apparatus.

26. The fast steady state field analysis method according to claim 25, wherein the physical quantity corrected by the first correcting apparatus is displayed on a display apparatus.
